(19) United States
(12) Patent Application Publication
(10) Pub. No.: US 2012/0090650 A1
(43) Pub. Date: Apr. 19, 2012

(54) DEVICE AND IMPLEMENTATION FOR STORING ENERGY IN AN APPLIANCE

(76) Inventor: Ronald Scott Tarr, Louisville, KY (US)

(21) Appl. No.: 12/952,285

(22) Filed: Nov. 23, 2010

(51) Int. Cl. B08B 3/00; F28F 7/00

(52) U.S. Cl. 134/105; 165/185

(57) ABSTRACT

An appliance for washing objects is described that can store energy from a first fluid such as washing fluid that drains from a basin in the appliance. The appliance is likewise configured to transfer the stored energy to a second fluid, which in one example is a washing fluid received from a fluid supply such as a municipal water supply. In one embodiment, the appliance comprises a thermal retention device with a fluid conducting feature through which flows the first fluid and the second fluid so as to raise the temperature of the second fluid before the second fluid flows directly into the basin of the appliance.

### BACKGROUND OF THE INVENTION

The subject matter disclosed herein relates generally to appliances and, more particularly, to appliances that are configured to transfer heat energy from fluid that drains from the appliance to fluid that flows into the appliance.

Appliances such as household dishwashers operate by way of several fill and drain cycles. During each of these cycles, washing fluid such as water flows into the appliance, heats to a pre-set temperature, and then circulates in a manner that cleans the objects (e.g., dishes, dishware, etc.) disposed therein. When the cleaning cycle is complete, the washing fluid drains from the appliance and fresh washing fluid flows into the appliance for the start of a new washing cycle.

Because it is preferred to subject the objects to washing fluid at elevated temperatures, the washing fluid is hot (e.g., at a temperature of about 60° C.) when it is drained in preparation for the next washing cycle. On the other hand, the fresh washing fluid is at a much lower temperature because this fluid is derived from a municipal supply that is connected to the home. The temperature of the fresh washing fluid is elevated in one example by way of a heating element disposed in the appliance. The heating element consumes energy to raise the temperature of the fresh washing fluid. The amount of energy is related to the change in temperature of the fresh washing fluid between an initial temperature and the elevated temperature that is required for the wash cycle. It follows then that less energy is consumed by the heating element to effectuate a smaller the change in temperature as between the initial temperature and the preferred elevated temperature.

Raising the temperature of the fresh washing fluid as it flows into the appliance is one way to reduce the amount of energy consumed by the appliance. Because the drained washing fluid is hot, it is a source of thermal energy, which can be used to raise the temperature of the fresh washing fluid. However, conventional appliances are rarely equipped to capture any this thermal energy or to transfer this thermal energy to the fresh washing fluid.

Exemplary techniques that are useful to capture the thermal energy in the drained washing fluid may include heat exchangers, in which the fresh washing fluid is passed in proximity to the draining washing fluid. Although thermal energy is transferred using this technique, thereby effectuating the desired change in temperature of the fresh washing fluid, the fresh washing fluid at the elevated temperature cannot flow directly into the interior of the appliance. Rather direct flow would contaminate the fresh washing fluid because of mixing that would occur with the draining washing fluid, which is typically still draining out of the appliance as the fresh washing fluid enters the appliance. To avoid contamination, heat exchangers store the fresh washing fluid in a reservoir until such time as the appliance is free from the draining washing fluid. Often the reservoir is itself heated to maintain and/or pre-heat the fresh washing fluid before it enters the appliance.

It would therefore be advantageous to configure an appliance to capture the thermal energy in the drained washing fluid and to transfer the captured energy to the fresh washing fluid. It would be even more advantageous for the appliance to be configured to flow the fresh washing fluid, heated by way of the energy transfer, directly into the appliance.

### BRIEF DESCRIPTION OF THE INVENTION

In one embodiment, an appliance comprises an enclosure forming a basin and a thermal retention device in flow communication with the basin. The appliance also comprises a fluid inlet coupled to the thermal retention device and a flow control device coupled between the thermal retention device and each of the basin and the fluid inlet. The appliance is further configured wherein the thermal retention device is configured to conduct heat energy from a first fluid to a second fluid, wherein the thermal retention device is configured to receive the first fluid from the basin and the second fluid from the fluid inlet, and wherein the flow control device has a first configuration that prevents the flow of the first fluid from the basin to the thermal retention device and permits the flow of the second fluid from the thermal retention device into the basin.

In another embodiment, a thermal retention device comprises a body having a longitudinal axis and fluid conducting features configured to conduct fluid through the body. The fluid conducting features comprise a first feature that is configured to conduct a first fluid and a second feature that is configured to conduct a second fluid. The thermal retention device is further configured wherein the body is configured to conduct heat energy from the first fluid to the second fluid and wherein the second feature has a surface area that is greater than the surface area of the first feature.

### BRIEF DESCRIPTION OF THE DRAWINGS

Reference is now made briefly to the accompanying drawings, in which:

FIG. 1 is a schematic diagram of an embodiment of an appliance for washing objects.

FIG. 2 is a side, cross-sectional view of an exemplary embodiment of a thermal retention device.

FIG. 3 is a perspective view of another exemplary embodiment of a thermal retention device.

FIG. 4 is a side, cross-sectional view of the thermal retention device of FIG. 3.

FIG. 5 is a side, perspective view of another embodiment of a thermal retention device.

FIG. 6 is a side, elevation, partially broken view of another exemplary embodiment of an appliance for washing dishes and which comprises a thermal retention device such as the thermal retention devices of FIGS. 2-5.

FIG. 7 is a flow diagram of a method for heating fluid in an appliance.

FIG. 8 is a schematic diagram of an example of a control configuration for use with an appliance such as the appliances of FIGS. 1 and 6.

FIG. 9 is a flow diagram of an example of an operational cycle for an appliance such as the appliances of FIGS. 1 and 6.

FIG. 10 is a top, perspective view of yet another exemplary embodiment of a thermal retention device.

FIG. 11 is a plot of temperature data collected from the thermal retention device of FIG. 10.

FIG. 12 is a top, perspective view of still yet another exemplary embodiment of a thermal retention device.

FIG. 13 is a plot of temperature data collected from the thermal retention device of FIG. 12.

Where applicable like reference characters designate identical or corresponding components and units throughout the several views, which are not to scale unless otherwise indicated.

### DETAILED DESCRIPTION OF THE INVENTION

Discussed in more detail below are appliances for washing objects (e.g., dishes, dishware, and articles of clothing) that incorporate concepts and features to store thermal energy from a fluid drained from the interior of the appliance. The stored energy is retained for at least a period of time such as between the completion of a drain cycle and the execution of a fill cycle. The appliance is configured to transfer the stored energy to another fluid that flows into the interior of the appliance.

Implementation of these concepts is particularly useful because such appliances do not require elements such as tanks and reservoirs, which are often coupled to heat exchangers and similar devices. This feature reduces the complexity of the resulting appliance and, more particularly, simplifies the transfer of fluid about the components of the appliance.

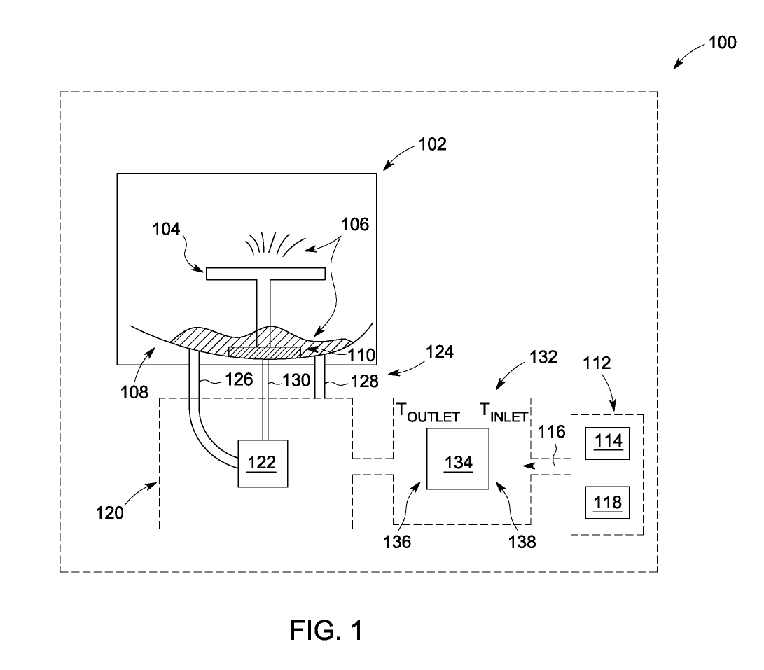

By way of example, and with reference now to the schematic diagram of FIG. 1, there is depicted an exemplary embodiment of an appliance 100 that includes an enclosure 102 and a spray system 104 for dispensing a first fluid 106. The enclosure 102 is configured with a basin 108 and a heating element 110. This combination is used to elevate the temperature of the first fluid 106, which is preferred for cleaning soiled objects (not shown) in the appliance 100. The objects can include dishware, commonly washed in a conventional dishwasher, as well as articles of clothing washed in a conventional washing machine. An inlet/outlet 112 is provided to permit ingress and egress of fluid into and out of the appliance 100. The inlet/outlet 112 comprises a fluid inlet 114 coupled to, for example, a municipal water supply that provides a second fluid 116, and a fluid outlet 118 that is secured to drainage or other means for disposing of wastewater in, e.g., a house or an office.

The appliance 100 is also equipped with a fluid distribution system 120, which is coupled to the spray system 104, the basin 108, the fluid inlet 114, and the fluid outlet 118. In one embodiment, the fluid distribution system 120 includes a pump 122 that is used to pressurize and distribute the first fluid 106 such as from the basin 108 to the spray system 104. The pump 122 is coupled to a conduit matrix 124 that is constructed of tubes, pipes, fittings, valves, and related elements that are useful to transport fluids such as the first fluid 106 and the second fluid 116. The conduit matrix 124 is configured with a basin drain 126 and a basin inlet 128 that are coupled to the basin 108, and a spray inlet 130 that is coupled to the spray system 104. Coupled to the fluid distribution system 120 is an energy retention system, identified generally by the numeral 132. The energy retention system 132 comprises a thermal retention device 134, which is in flow communication with the enclosure 102 on a drain or first side 136 and which is coupled to the inlet/outlet 112 on an inlet or second side 138.

The thermal retention device 134 is configured to store and to conduct heat energy from the first fluid 106 to the second fluid 116. In one example, the thermal retention device 134 is configured to receive the first fluid 106, hereinafter “the hot drain fluid,” from the enclosure 102, such as through the basin drain 126. Having been utilized to clean the objects in the enclosure, the hot drain fluid is often at an elevated temperature, which is in one example from about 50° C. to about 60° C. The hot drain fluid flows from the drain side 136 to the inlet side 138 of the thermal retention device 134 and out of the appliance 100 via the fluid outlet 118. This flow increases the temperature of the thermal retention device 134. This increase is indicative of conduction of heat from the hot drain fluid to the thermal retention device 134, and more particularly to an increase in the thermal energy of the thermal retention device 134.

The thermal retention device 134 is also configured to distribute thermal energy to the second fluid 116, hereinafter “the cold inlet fluid.” In one example, the thermal retention device 134 is configured to receive the cold inlet fluid from the fluid inlet 114. The cold inlet fluid flows from the inlet side 138 to the drain side 136 of the thermal retention device 134, and in one example the cold inlet fluid thereafter flows directly into the basin 108 via the basin inlet 128. Examples of the appliance 100 are contemplated in which the cold inlet fluid flows under its own pressure into the basin 108 as well as with the aid of, e.g., the pump 122.

Flowing the cold inlet fluid through the thermal retention device 134 changes the temperature of the cold inlet fluid from an inlet temperature Tᵢₙₗₑₜ at the inlet side 138 to an outlet temperature Tₒᵤₜₗₑₜ at the drain side 136. In one example, the inlet temperature Tᵢₙₗₑₜ is less than the elevated temperature of the hot drain fluid, and more likely consistent with the temperature of the municipal water supply such as less than about 10° C. The change in temperature of the second fluid can vary as with the construction of the thermal retention device 134 and/or the energy retention system 132 in general.

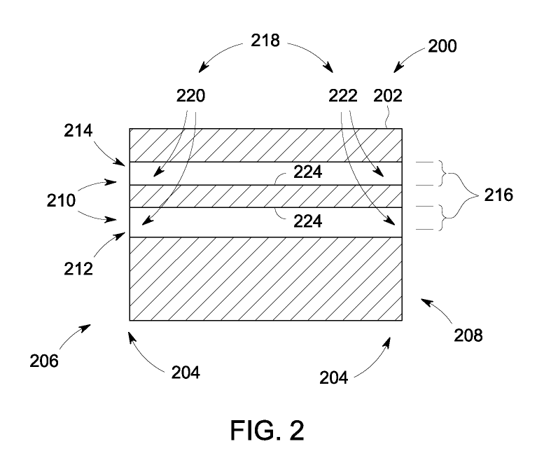

Focusing now on construction of the energy retention system 132, reference can be had to FIG. 2, in which is illustrated a cross-section of an exemplary embodiment of a thermal retention device 200 for use as the thermal retention device 134 (FIG. 1). The thermal retention device 200 includes a body 202 with opposing sides 204 that include a drain or first side 206 and an inlet or second side 208. The body 202 includes one or more fluid conducting features 210 that comprise in one example a drain fluid or first feature 212 and an inlet fluid or second feature 214. Each of the fluid conducting features 210 comprise an aperture 216 extending through the body 202. The aperture 216 terminates at openings 218 such as the drain side openings 220 and the inlet side openings 222. Each aperture 216 defines a surface 224 through which heat energy is transferred to and from the body 202. The combination, location, and configuration of each of the drain fluid feature 212 and inlet fluid feature 214 are selected to change the temperature of the cold inlet fluid as between, for example, the inlet temperature Tᵢₙₗₑₜ and the outlet temperature Tₒᵤₜₗₑₜ as contemplated herein. Exemplary constructions are contemplated in which the first features and the second feature are configured to change the temperature of the second fluid by at least about 3° C., and in one construction the change is from about 5° C. to about 8° C.

The body 202 can be constructed using typical manufacturing techniques such as machining, turning, casting, extruding, and similar techniques for manipulating materials. Materials for use in the body 202 can comprise aluminum, steel, stainless steel, as well as combinations and derivations of these and other thermally conductive materials. Materials of construction that are selected exhibit certain material properties, and in one example the thermal conductivity of the material is at least about 200 W/m*K and the specific heat capacity is at least about 20 J/mol*K. In one example, the thermal conductivity is about 237 W/m*K and the specific heat capacity is about 24 J/mol*K.

The body 202 can be constructed monolithically as illustrated in the present example or from a plurality of pieces and components that are constructed and assembled together using fastening techniques such as welding and other fasteners compatible with the concepts disclosed herein. Multi-piece construction may permit the use of different materials and composites, therefore providing flexibility to tune the thermal properties of the body 202 via the combination materials with different thermal conductivity. By way of example the body 202 can comprise a first material such as aluminum, which is machined so as to have the fluid conducting features 210 incorporated therein. Tubing such as copper tubing or aluminum tubing can be pressed into the fluid conducting features 210 thereafter creating the surface 224 through which flows the washing fluid.

In other constructions the body 202 is constructed from a composite or other combination of thermally conductive materials selected and combined so as to optimize the thermal properties of the thermal retention device 200. The combination of materials may include both thermally active materials, e.g., materials with high thermal conductivity, and thermally inactive or insulator materials, e.g., materials with low thermal conductivity. The insulator materials can be used to direct the conduction of heat energy to areas of the body 202 such as, for example, the fluid conducting features 210.

Though not shown in FIG. 2, the drain side openings 220 and the inlet side openings 222 can be configured such as with threads and/or threaded fasteners to facilitate coupling with, e.g., the conduit matrix 124 (FIG. 1). Fittings such as pipe fittings and quick-release fittings can be implemented on or about the body 202. These fittings permit the body 202 to be inserted as, for example, a replacement part or upgrade to an existing appliance. In one example, the body 202 is fixedly secured as part of, e.g., the fluid distribution system 120 (FIG. 1). Solder, adhesives, and related fastenings can be used to secure the body 202 in the appliance.

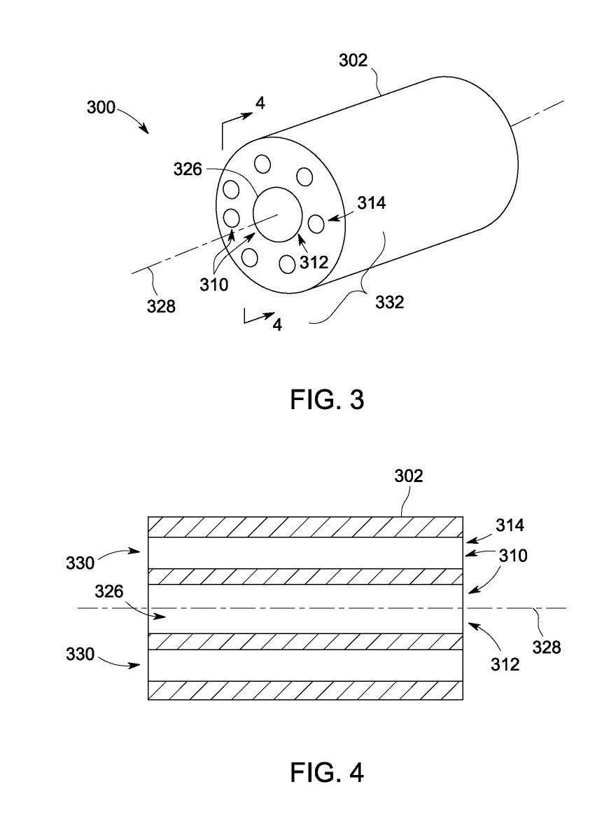

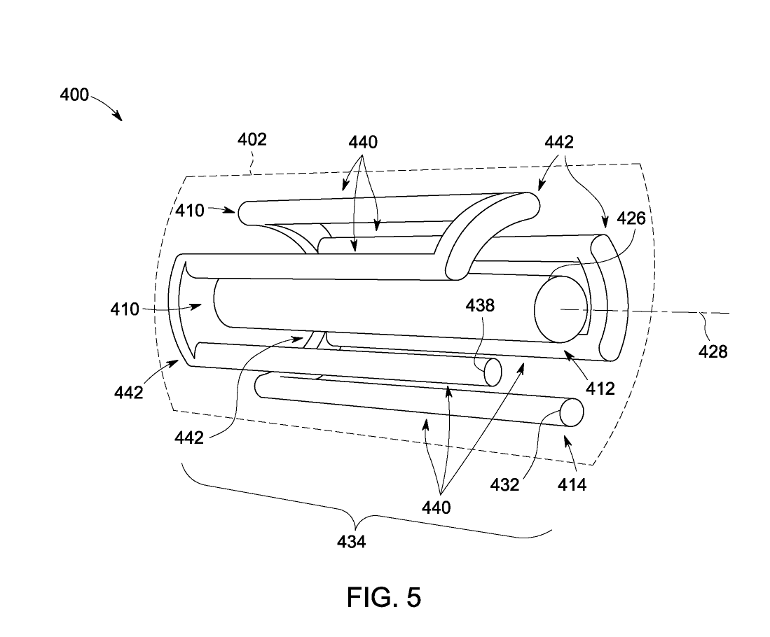

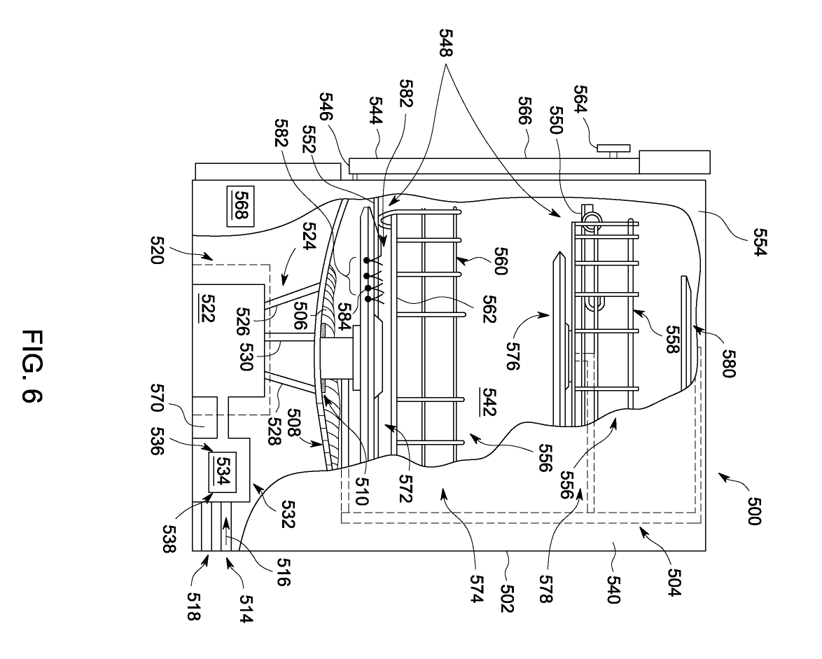

Other constructions of thermal retention devices of the present disclosure are found in FIGS. 3-5. These figures illustrate exemplary embodiments of a thermal retention device 300 (FIGS. 3 and 4) and 400 (FIG. 5). Like numerals are used to identify like components as between the FIG. 2 and FIGS. 3-5, but the numerals are increased (e.g., 200 is 300 in FIGS. 3 and 4 and 300 is 400 in FIG. 5). Noted further is that while each of the thermal retention devices 200, 300, and 400 may comprise different features, the configurations of each are not exclusive. That is to say the features found and discussed in connection the thermal retention device 300 can be applied to embodiments of the thermal retention device 400, and vice versa.

Referring first to FIGS. 3 and 4, it is shown that the thermal retention device 300 includes a body 302 with fluid conducting features 310 such as a drain fluid or first feature 312 and an inlet fluid or second feature 314. In one embodiment, the drain fluid feature 312 comprises a centrally-located drain bore 326, and in one example the centrally-located drain bore 326 is concentric with and extends along a longitudinal axis 328 of the body 302. The inlet fluid feature 314 includes one or more inlet bores 330, which are arranged in the present example as an array 332. In one example, the inlet bores 330 are spaced, e.g., evenly spaced, radially about the longitudinal axis 328.

In FIG. 5, the thermal retention device 400 comprises a body 402 illustrated for clarity in phantom-line form. The body 402 includes fluid conducting features 410, including a drain fluid feature 412 and an inlet fluid feature 414. The drain fluid feature 412 includes a centrally-located drain bore 426 arranged concentric with and along a longitudinal axis 428 of the body 402. In one embodiment, the inlet fluid feature 414 comprises a circuitous inlet pathway 434 having a single inlet 436 and a single outlet 438, located in the present example on the same side of the body 402. The circuitous inlet pathway 434 includes a plurality of legs 440, which are arranged longitudinally relative to the longitudinal axis 428 and distributed radially about the centrally-located drain bore 426. A plurality of joints 442 is also provided to connect the plurality of legs 440. In one example, the second fluid 116 (FIG. 1) is conducted from the single inlet 436 to the single outlet 438 via the plurality of legs 440 and the plurality of joints 442.

With continued reference to FIGS. 3-5, configurations of the bodies (e.g., the body 302 and 402) and the fluid conducting features (e.g., the fluid conducting features 310 and 410) can vary as depicted in the present embodiments, as well as within other design parameters contemplated herein. While depicted as substantially elongated cylinders, the bodies can have other shapes including circular, rectangular, square, and elliptical, among many others. The shape may be determined in accordance with the particular application, i.e., the size and relative space available in the appliance.

The dimensions can also vary, being selected for example to fit within the appliance (e.g., the appliance 100 (FIG. 1)) and also to facilitate the change in temperature of the cold inlet fluid, e.g., between the inlet temperature Tᵢₙₗₑₜ and the outlet temperature Tₒᵤₜₗₑₜ discussed above. Suitable configurations for the bodies that include the circuitous inlet pathway 434 can include cylinders with diameters from about 50 mm to about 150 mm. Configurations are discussed below in the EXAMPLE I and the EXAMPLE II wherein the diameter is, respectively, about 75 mm and about 125 mm.

Feature configurations such as the shape and size of the bores (e.g., the centrally-located drain bore 326 and 426 of FIGS. 3-5) and other openings and apertures (e.g., the inlet bores 330 and the circuitous inlet pathway 434 of FIGS. 3-5) can also vary. Manufacturability and cost, as well as performance characteristics such as fluid flow are all considerations that can render impracticable certain configurations of such features. In one example, the features for use in conducting the first fluid 106 (FIG. 1) such as the centrally-located drain bore 326 and 426 have a nominal diameter of at least about 10 mm, wherein in one construction the nominal diameter is from about 12 mm to about 18 mm. For the features for conducting the second fluid 116 (FIG. 1), which include the inlet bores 330 and the circuitous inlet pathway 434 (including the legs 440 and the joints 442), the nominal diameter can be from about 4 mm to about 8 mm.

In other examples, the surface area of these features is used to determine various characteristics of the terminal retention device. Such characteristics include the location (including the location relative to the centrally-located drain bore 326 and 426), the nominal diameter, as well as the length of the circuitous inlet pathway 434 and the number of inlet bores 330 in the array 332. The length of the features can vary, for example, wherein in one example the length of the circuitous inlet pathway 434 (or second feature) is greater than the length of the body. This length is useful, for example, to increase the surface area that is available for heat transfer to occur, while the general configuration of the circuitous fluid pathway 434 maintains at a minimum the overall dimensions of the body 402.

In view of the foregoing, and with reference now to FIG. 6, embodiments of the thermal retention device (e.g., the thermal retention devices 200, 300, and 400 of FIGS. 2-5) can be implemented in a variety of appliances, including dishwashers, clothes washers, and the like. In FIG. 6, there is depicted another exemplary embodiment of an appliance 500, which is shown as a side, elevation view of a domestic dishwasher partially broken away. Like numerals are used to identify like components as between the FIGS. 1 and 6, except that the numerals are increased by 400.

By way of example, there is illustrated that the appliance 500 includes an enclosure 502 and a spray system 504 for dispensing a first fluid 506. A fluid inlet 514 provides a second fluid 516. The appliance 500 also comprises a fluid outlet 518 and a fluid distribution system 520 with a pump 522. A conduit matrix 524 is configured with a basin drain 526 and a basin inlet 528 that are coupled to the basin 508, and a spray inlet 530 coupled to the spray system 504. The appliance 500 is equipped with an energy retention system 532, in which a thermal retention device 534 has a drain side 536 and an inlet side 538 coupled, respectively, to the pump 522 and to the fluid inlet 514 and fluid outlet 518.

Particular to the example of FIG. 6, the enclosure 502 includes a cabinet 540 having a tub 542 therein and forming a wash chamber. The tub 542 includes a front opening (not shown in FIG. 6) and a door 544 with a hinged bottom portion 546 such as for movement between a normally closed vertical position (shown in FIG. 6) and a normally open horizontal position (not shown). The wash chamber is sealed shut in the closed position for washing operation. The open position is useful for loading and unloading of objects from the appliance 500.

Guide rails 548 including an upper guide rail 550 and a lower guide rail 552 are mounted on enclosure side walls 554. The guide rails 548 accommodate one or more racks 556 such as an upper rack 558 and a lower rack 560 (hereinafter, “the racks”), respectively. Each of the racks is fabricated from known materials into lattice structures including a plurality of elongated members 562, and each is adapted for movement between an extended loading position (not shown) in which at least a portion of the racks are positioned outside the wash chamber, and a retracted position (shown in FIG. 6) in which the rack is located inside the wash chamber. In one implementation, a silverware basket (not shown) is removably attached to the lower rack 560 for placement of silverware, utensils, and the like that are too small to be accommodated by either one or both of the racks contemplated herein.

A control input selector 564 such as a keypad is mounted at a convenient location on an outer face 566 of the door 544 and is coupled to known control circuitry, which in one example is coupled to a controller 568. The control input selector 564 is also coupled to other control mechanisms (not shown) for operating, e.g., the pump 522 for circulating the first fluid 506 and other fluids (e.g., the second fluid 516) in the tub 542. In one embodiment, the fluid distribution system 520 including the pump 522 is located in a machinery compartment 570 located below the basin 508 of the tub 542.

Construction of the spray system 504 as provided in connection with the concepts of the present disclosure can vary. In one embodiment, the spray system 504 includes in the present example a lower spray-arm assembly 572, which is mounted for rotation within a lower region 574 of the wash chamber and above the basin 508 so as to rotate in relatively close proximity to the lower rack 560. A mid-level spray-arm assembly 576 is located in an upper region 578 of the wash chamber in close proximity to the upper rack 558. The mid-level spray-arm assembly 576 is located at a height above the lower rack 560 sufficient to accommodate items such as a dish or platter (not shown) that is placed in lower rack 560. In a further embodiment, an upper spray-arm assembly 580 is located above the upper rack 558, again being located at a height sufficient to accommodate a items expected to be placed in the upper rack 558, such as a glass (not shown) of a selected height.

One or more of the spray arm assemblies (e.g., the lower spray-arm assembly 572, the mid-level spray-arm assembly 576, and the upper spray-arm assembly 580) are fed by the pump 522. Each of the spray arm assemblies includes discharge ports 582 such as one or more spray jets 584, which are effectively orifices for directing the first fluid 506 onto objects (e.g., dishes) located in the racks. In one embodiment, the angle of the spray jets 584 is fixed such as relative to the spray arm assembly. The angle can vary, depending in part on the size of the wash chamber, the location of the spray arm assembly, and the number of racks, among many factors. In one particular construction of the appliance 500, one or more of the spray jets 584 affixed at about a 10° angle relative to the spray arm assembly.

The arrangement of the spray jets 584 in the spray arm assemblies can result in a rotational force as first fluid 506 flows through the spray jets 584. The resultant rotation of spray arm assemblies provides coverage of the objects with the first fluid 506. In one embodiment, one or more of the spray arm assemblies is likewise configured to rotate, generating in one example a swirling spray pattern above and below, e.g., the upper rack 558 when the pump 522 is activated.

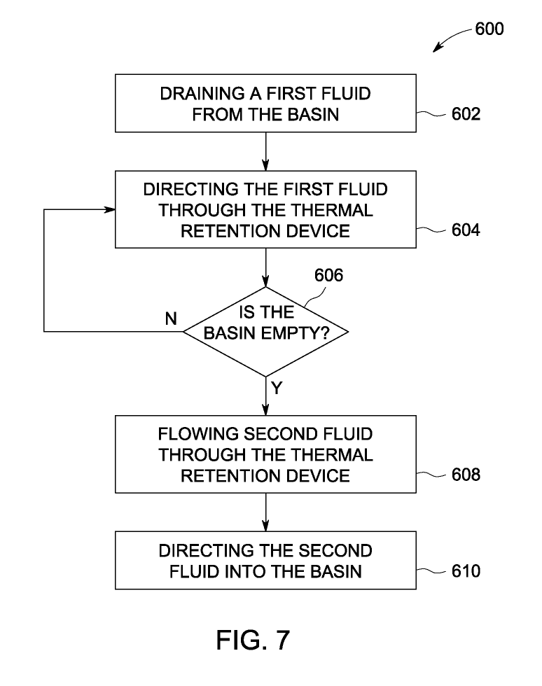

Referring next to FIG. 7, and also to FIG. 6, an exemplary embodiment of a method 600 for heating a washing fluid is illustrated. The method 600 comprises at block 602 draining a first fluid 506 from the basin 508 and at block 604 directing the first fluid 506 through the thermal retention device 534 to the fluid outlet 518 to store heat from the first fluid 506 in the thermal retention device 534.

The method 600 also comprises at block 606 determining if the basin 508 is empty of the first fluid 506. This determination may require sensors such as a sensor that monitors the height of the washing fluid in the basin and/or a sensor that monitors the flow of the washing fluid through the basin drain 526. In one embodiment, if the sensor indicates that there is first fluid 506 in the basin 508, then the method 600 continues to permit the first fluid 506 to flow out of the basin 508 and to the thermal retention device 534. Other configurations are also contemplated wherein the draining procedure is accomplished without sensors, but rather the pump 522 is turned on for a fixed period of time. In one example, this fixed period is long enough so that substantially all of the first fluid 506 is drained out the appliance. It is contemplated, however, that some residual amounts of the first fluid 506 may be left in the appliance due in part, for example, to manufacturing and material defects and tolerances that are commonplace with appliances such as those contemplated herein.

If the basin 508 is empty of the first fluid 506, such as identified by the sensors above, then the method 600 further comprises at block 608 flowing a second fluid 516 into the thermal retention device 534 and at block 610 directing the second fluid 516 to the basin inlet 528. The second fluid 516 can be derived from the municipal supply, which is at a temperature that is less than the temperature of the first fluid 506. Flowing the second fluid 516 into the thermal retention device 534 increases its temperature such as from the temperature Tᵢₙₗₑₜ to the temperature Tₒᵤₜₗₑₜ using the heat energy from the first fluid 506 that is stored in the terminal retention device 534.

As contemplated herein, this arrangement and process are advantageous to avoid mixing and contamination of the second fluid 516 with the first fluid 506 that is drained from the basin 508. Moreover, the thermal energy of the first fluid 506 is captured and transferred to the second fluid 516 without the need to store the second fluid 516 before it is allowed to flow into the basin 508. By way of implementation of the thermal retention device 534, less energy is used because the basin 508 is filled with the second fluid 516, which is at or near the temperature Tₒᵤₜₗₑₜ when the second fluid 516 enters the basin 508. The appliance 500 is therefore only required to heat the second fluid 516 from the temperature Tₒᵤₜₗₑₜ to the temperature desired for a wash cycle.

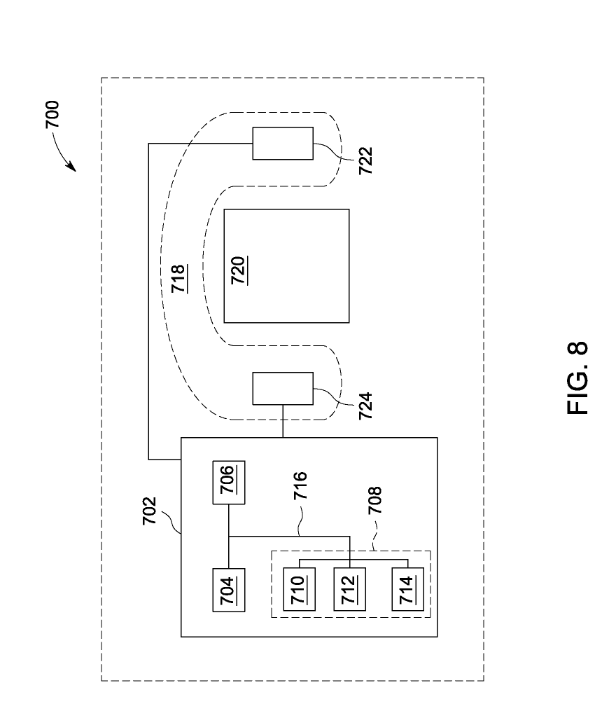

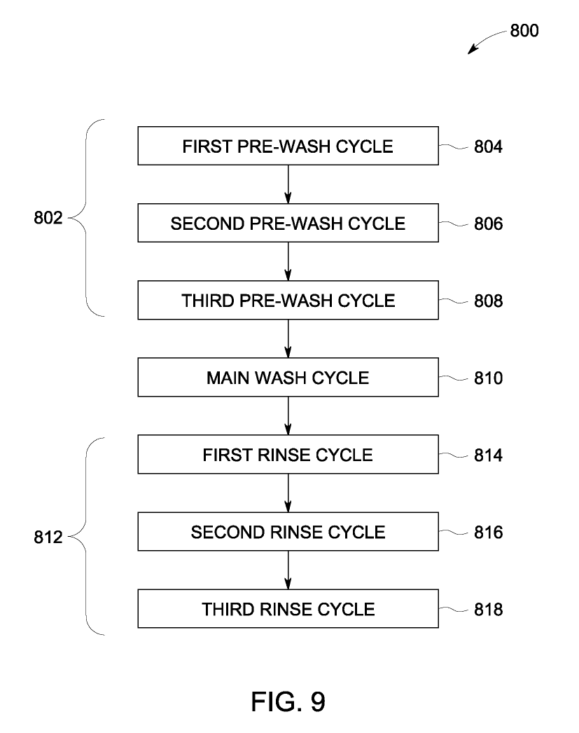

A variety of control configurations and schemes can be used to implement operation of the appliances, thereby effectuating the method 600 above and related operational cycles (e.g., an operational cycle 800 of FIG. 9 below). An example of the control structure and circuitry can be had with reference next to FIG. 8. The present example of FIG. 8 provides, in part, a schematic diagram of one configuration of a control scheme 700 for use in, e.g., the appliances 100 and 500, as well as related embodiments (“the appliances”).

The control scheme 700 includes a controller 702 (e.g., the controller 568 of FIG. 6), which includes a processor 704, a memory 706, and control circuitry 708 configured for general operation of the appliances. The control circuitry 708 comprises a pump motor control circuit 710, a heater control circuit 712, and a timing circuit 714. All of these components are coupled together and communicate with one another via one or more busses 716. Also illustrated in the control scheme 700 is a flow control device 718, which is coupled between the thermal retention device 720 and each of the enclosure (e.g., the enclosure 102 and 502) and the fluid inlet (e.g., the fluid inlet 114 and 514).

The flow control device 718 controls the flow of fluid (e.g., the first fluid 106 and 506 and the second fluid 116 and 516) into and out of a thermal retention device 720. The flow control device 718 comprises a valve 722 and a pump 724. In one embodiment, the flow control device 718 has a first configuration that prevents the flow of the first fluid from the enclosure to the thermal retention device 720 and permits the flow of the second fluid from the thermal retention device into the enclosure. The pump 724 may be inactive during the first configuration, thereby preventing the first fluid from reaching the thermal retention device. Likewise the valve 722 may be open in the first configuration so that the second fluid flows through the valve to the thermal retention device 720. The flow control device 718 can also have a second configuration in which the first fluid it permitted to flow from the enclosure to the thermal retention device 720 such as by activating the pump 724. In the second configuration, the valve 722 may be closed to prevent the first fluid from the thermal retention device 720.

When implemented in the appliances, the controller 702 is configured to execute an operational cycle (e.g., the operational cycle 800 in FIG. 9) that instructs the flow control device 718 to enter the first configuration and the second configuration. The timing circuit 714, of which various configurations are contemplated, is provided to indicate times and time periods to, e.g., open and close the valve 722 and activate and inactivate the pump 724. These time periods may be selected, in connection with or wholly separate from the configuration of the thermal retention device 720, to improve the heat energy recovered from the hot drain fluid as contemplated herein. Timing selections can in one example be implemented as part one or more of the wash cycles (e.g., a pre-wash portion 802, a main wash cycle 810, and a rinse portion 812 in FIG. 9). In one example, the time periods are selected so that the valve 722 is opened after the pump 724 is rendered inactive.

Configurations of the controller 702 include one or more groups of electrical circuits that are each configured to operate, separately or in conjunction with other electrical circuits, to selectively vary among other things the timing and operation of the flow control device 718. The controller 702 and its constructive components are configured to communicate amongst themselves and/or with other circuits (and/or devices), which execute high-level logic functions, algorithms, as well as firmware and software instructions. Exemplary circuits of this type include, but are not limited to, discrete elements such as resistors, transistors, diodes, switches, and capacitors, as well as microprocessors and other logic devices such as field programmable gate arrays (“FPGAs”) and application specific integrated circuits (“ASICs”). While all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

The electrical circuits of the controller 702 are sometimes implemented in a manner that can physically manifest logical operations, which are useful to facilitate the various flow control operations such as opening and closing the valve 722 and pump 724. These electrical circuits can replicate in physical form an algorithm, a comparative analysis, and/or a decisional logic tree, each of which operates to assign the output and/or a value to the output that correctly reflects one or more of the nature, content, and origin of the changes that occur and that are reflected by the relative inputs to the valve 722 and pump 724.

In one embodiment, the processor 704 is a central processing unit (CPU) such as an ASIC and/or an FPGA that is configured to the control operation of the flow control device 718. The processor 704 can also include state machine circuitry or other suitable components capable of controlling operation of, e.g., the pump 122 and 522 as described herein. The memory 706 includes volatile and non-volatile memory and can be used for storage of software (or firmware) instructions and configuration settings. Each of the pump motor control circuit 710, the heater control circuit 712, and the timing circuit 714 can be embodied as stand-alone devices such as solid-state devices. These devices can be mounted to substrates such as printed-circuit boards, which can accommodate various components including the processor 704, the memory 706, and other related circuitry to facilitate operation of the controller 702 in connection with its implementation in the appliances 100 and 500.

However, although FIG. 8 shows the processor 704, the memory 706, the a pump motor control circuit 710, a heater control circuit 712, and a timing circuit 714 as discrete circuitry and combinations of discrete components, this need not be the case. For example, one or more of these components can be contained in a single integrated circuit (IC) or other component. As another example, the processor 704 can include internal program memory such as RAM and/or ROM. Similarly, any one or more of functions of these components can be distributed across additional components (e.g., multiple processors or other components).

Operation of the appliances and implementation of the methods contemplated herein can be incorporated into one or more different operational cycles. One example of an operational cycle is illustrated in FIG. 9, in which there is depicted an example of an operational cycle 800. The operational cycle 800 can be implemented on the appliances 100 and 500 (“the appliances”). Typically, the appliances employ a series of wash cycles, which include pre-wash, wash, and rinse cycles having a preset operation time for washing the objects.

In the illustrated embodiment, the operational cycle 800 includes a pre-wash portion 802 that is effectuated by a first pre-wash cycle 804, a second pre-wash cycle 806, and a third pre-wash cycle 808. The pre-wash portion 802 is used to remove loose particles from the dishes. Further, the operational cycle 800 includes a main wash cycle 810 for washing the dishes. In addition, the operational cycle 800 includes a rinse portion 812, including in this example a first rinse cycle 814, a second rinse cycle 816, and a third rinse cycle 818.

### EXPERIMENTAL EXAMPLES

For further clarification, instruction, and description of the concepts above, embodiments of the present disclosure are now illustrated and discussed in connection with the following examples. Note that any dimensions provided in connection with these examples are exemplary only and should not be used to limit any of the embodiments of the invention, as it is contemplated that actual dimensions will vary depending on the practice and implementation of the concepts discussed herein as well as variety of factors such as, but not limited to, the size of the appliance, the flow rate of one or more of the first fluid and the second fluid, the desired rate of heat transfer, the efficiency of heat transfer, and the like.

### Example I

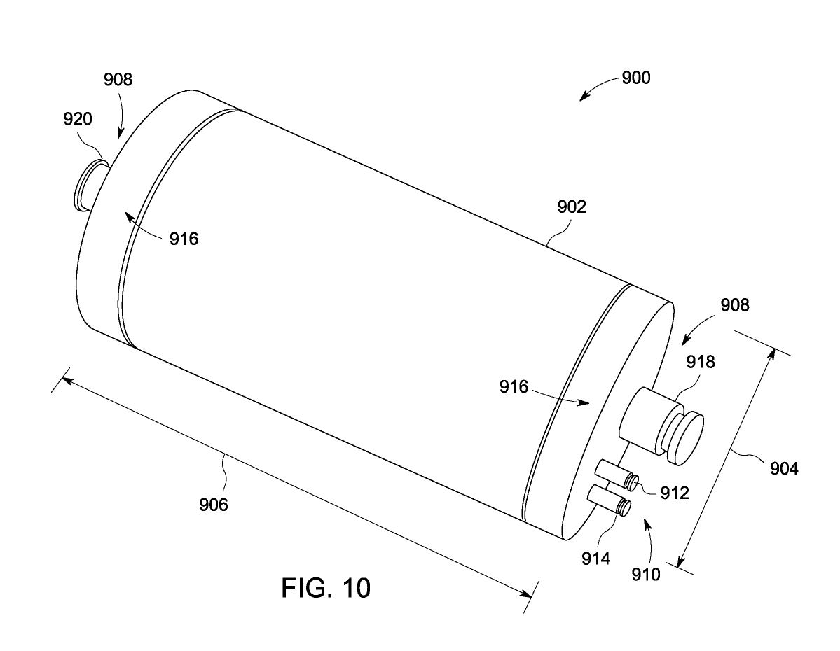

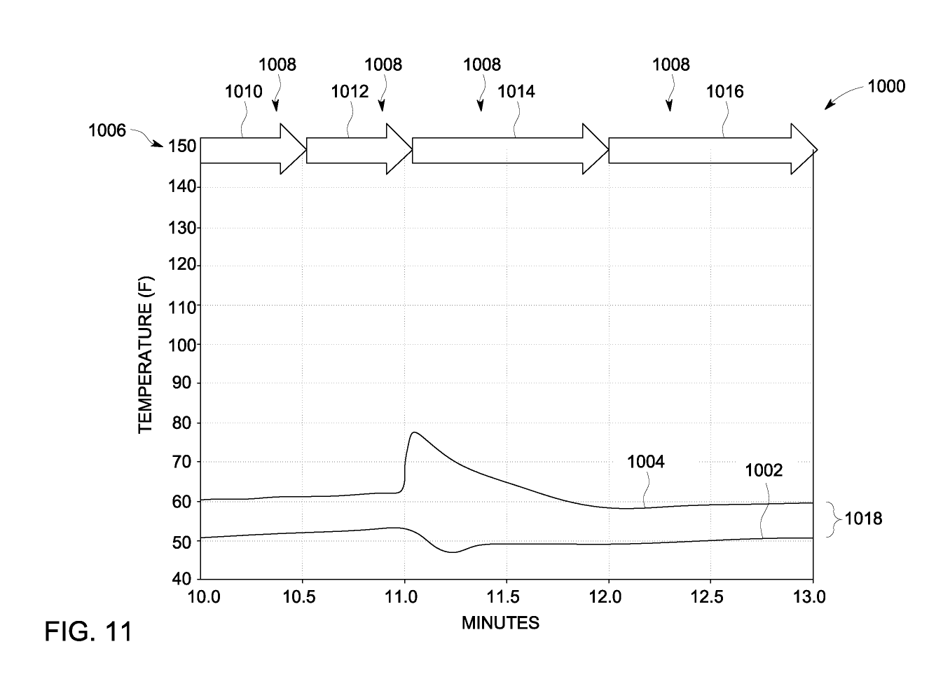

Referring now to FIGS. 10 and 11, in one experimental example, a thermal retention device 900 comprises a cylindrical body 902 having an outer diameter 904 of about 75 mm and a length 906 of about 125 mm. The cylindrical body 902 is constructed entirely of aluminum in which various features are machined and manufactured using conventional techniques. Attached to the outside of the cylindrical body 902 is a plurality of fittings 908 that included cold fittings 910 such as a cold inlet fitting 912 and a cold outlet fitting 914. The fittings 908 also comprise hot fittings 916 such as a hot inlet fitting 918 and a hot outlet fitting 920.

Inside of the cylindrical body 902 there is constructed certain fluid conducting features (e.g., the fluid conducting features 210, 310, and 410 of FIGS. 2-5) (not shown). The configuration of these conducting features of which includes a hot fluid conducting feature that comprises a bore through the cylindrical body 902 with an inside diameter of about 15 mm. This configuration also includes a cold fluid conducting feature in the form of a circuitous inlet pathway (e.g., the circuitous inlet pathway 434 (FIG. 5)) with an average inner diameter of about 6 mm. In its present configuration, the circuitous inlet pathway provides a surface area of about 14,000 mm² within the cylindrical body 902.

In FIG. 11 there is illustrated a plot 1000 of the temperature for a cold inlet fluid, wherein the temperature is recorded at or before the cold inlet fitting 912 (FIG. 10) as the temperature Tᵢₙₗₑₜ discussed above and identified on the plot 1000 as item 1002. The temperature is also recorded at or after the cold outlet fitting 914 (FIG. 10) as the temperature Tₒᵤₜₗₑₜ discussed above and identified on the plot 1000 as item 1004.

In one example, a test procedure 1006 comprises a number of steps 1008, which are utilized to gather the data for the plot 1000. The steps 1008 are similar, although not necessarily exact, to at least a portion of an operating cycle (e.g., the operational cycle 800 (FIG. 9)) in which the washing fluid is drained from the interior of the appliance and flows through the thermal retention device; and cold inlet washing fluid flows through thru the thermal retention device and is injected into the interior of the appliance as contemplated herein.

In one implementation of the test procedure 1006, a hot fluid (e.g., water) at a nominal temperature of about 60° C. was flowed into the hot fittings 916 for about 30 seconds (step 1010). The flow of the hot fluid was stopped for about 30 seconds (step 1012). Thereafter a cold fluid (e.g., water) at a nominal temperature of 10° C. was flowed into the cold fittings 910, and into the circuitous inlet pathway, for about 60 seconds (step 1014). Monitoring of the temperature of the cold inlet fluid was continued (step 1016) thereafter as indicated by the plot 1000.

As depicted in the plot 1000, and indicated by the numeral 1018, implementation of these concepts changes the temperature of the cold inlet fluid. In one example, the change is about 3° C.

### Example II

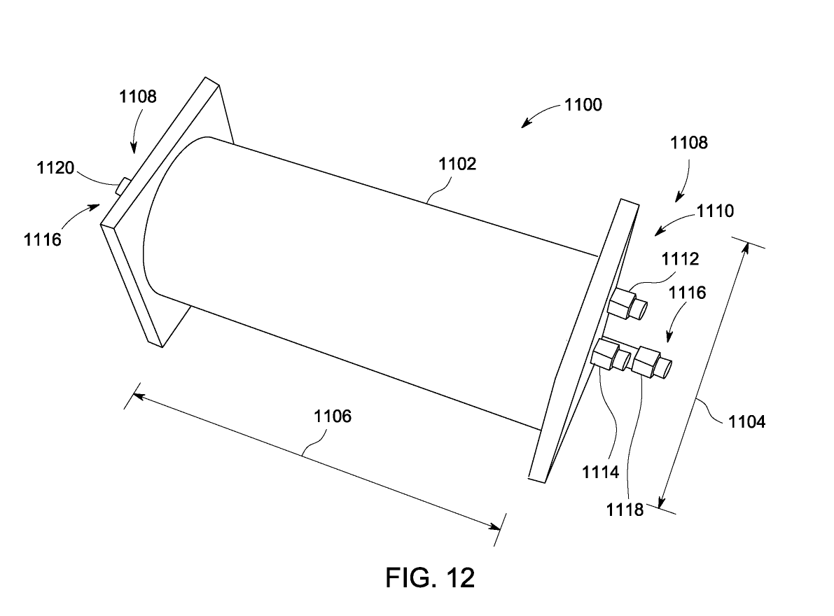

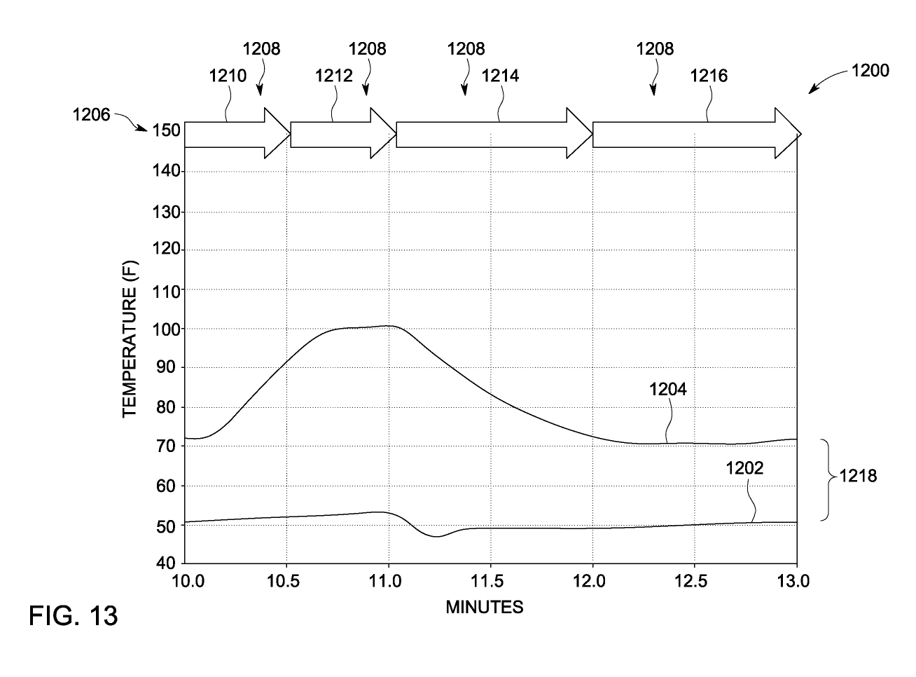

Referring now to FIGS. 12 and 13, in one experimental example, a thermal retention device 1100 comprised a cylindrical body 1102 having an outer diameter 1104 of about 125 mm and a length 1106 of about 300 mm. The cylindrical body 1102 was constructed entirely of aluminum in which various features are machined and manufactured using conventional techniques. Attached to the outside of the cylindrical body 1102 is a plurality of fittings 1108 that included cold fittings 1110 such as a cold inlet fitting 1112 and a cold outlet fitting 1114. The fittings 1108 also comprise hot fittings 1116 such as a hot inlet fitting 1118 and a hot outlet fitting 1120.

Inside of the cylindrical body 1102 is provided certain fluid conducting features (e.g., the fluid conducting features 210, 310, and 410 of FIGS. 2-5) (not shown). The configuration of these conducting features of which includes a hot fluid conducting feature that comprises a bore through the cylindrical body 1102 with an inside diameter of about 15 mm. This configuration also includes a cold fluid conducting feature in the form of a circuitous inlet pathway (e.g., the circuitous inlet pathway 434 (FIG. 5)) with an average inner diameter of about 6 mm, and which provides a surface area of about 35,000 mm² within the cylindrical body 1102.

In FIG. 13 there is illustrated a plot 1200 of the temperature for a cold inlet fluid. The temperature is recorded at or before the cold inlet fitting 1112 (FIG. 12) as the temperature Tᵢₙₗₑₜ, the reading of which is identified on the plot 1200 as item 1202. The temperature is also recorded at or after the cold outlet fitting 1114 (FIG. 12), as the temperature Tₒᵤₜₗₑₜ, which is identified on the plot 1200 as item 1204.

In one example, a test procedure 1206 that comprises a number of steps 1208 was utilized to gather the data for the plot 1200. The steps 1208 are similar, although not necessarily exact in parameters, to at least a portion of an operating cycle (e.g., the operational cycle 800 of FIG. 9) in which the washing fluid is drained from the interior of the appliance and flowed through the thermal retention device, and cold inlet washing fluid is injected into the interior via the thermal retention unit as contemplated herein.

In one implementation of the test procedure 1206, a hot fluid (e.g., water) at a nominal temperature of about 60° C. was flowed into the hot fittings 1116 for about 30 seconds (step 1210). The flow of the hot fluid was stopped for about 30 seconds (step 1212). Thereafter a cold fluid (e.g., water) at a nominal temperature of 10° C. was flowed through the cold fittings 1110 and into the circuitous inlet pathway for about 60 seconds (step 1214). Monitoring of the temperature of the cold inlet fluid was continued (step 1216) thereafter as indicated by the plot 1200.

As depicted in the plot 1200 and indicated by the numeral 1218, implementation of the concepts contemplated herein changes the temperature of the cold inlet fluid. In one example, the change is about 8° C.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

This written description uses examples to disclose embodiments of the invention, including the best mode, and also to enable any person skilled in the art to practice the invention, including making and using any devices or systems and performing any incorporated methods. The patentable scope of the invention is defied by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An appliance, comprising:
an enclosure forming a basin that is configured to capture a washing fluid;
a thermal retention device in flow communication with the basin;
a fluid inlet coupled to the thermal retention device; and
a flow control device coupled between the thermal retention device and each of the basin and the fluid inlet,
wherein the thermal retention device is configured to conduct heat energy from a first fluid to a second fluid,
wherein the thermal retention device is configured to receive the first fluid from the basin and the second fluid from the fluid inlet, and
wherein the flow control device has a first configuration that prevents the flow of the first fluid from the basin to the thermal retention device and permits the flow of the second fluid from the thermal retention device into the basin.

2. An appliance according to claim 1, wherein the flow control device comprises a pump in flow communication with the enclosure and the thermal retention device, wherein the pump transfers the first fluid from the basin to the thermal retention device, and wherein the pump is inactive in the first configuration.

3. An appliance according to claim 1, wherein the flow control device comprises a valve in flow communication with each of the fluid inlet and the thermal retention device, wherein the second fluid flows through the valve to the thermal retention device, and wherein the valve is open in the first configuration.

4. An appliance according to claim 1, further comprising a controller, wherein the controller is configured to execute a wash cycle that instructs the flow control device to enter the first configuration.

5. An appliance according to claim 4, wherein the wash cycle instructs the flow control device to enter a second configuration in which the first fluid is permitted to flow from the basin to the thermal retention device.

6. An appliance according to claim 1, wherein the basin is configured to retain objects therein, and wherein the objects comprise at least one of dishware and articles of clothing.

7. An appliance according to claim 1, wherein the thermal retention device has an inlet and an outlet, wherein the second fluid has first temperature at the inlet and a second temperature at the outlet, wherein the second temperature is greater than the first temperature, and wherein the second fluid flows from the thermal retention device into the basin at the second temperature.

8. An appliance according to claim 1, wherein the thermal retention device comprises a body, wherein the first fluid flows through a first feature of the body, and wherein the second fluid flow through a second feature of the body.

9. An appliance according to claim 8, wherein each of the first feature and the second feature have a surface area, and wherein the surface area of the first feature is less than the surface area of the second feature.

10. An appliance according to claim 8, wherein the first feature and the second feature are configured to change the temperature of the second fluid by at least about 3° C.

11. A thermal retention device, comprising:
a body having a longitudinal axis; and
fluid conducting features configured to conduct fluid through the body, the fluid conducting features comprising a first feature that is configured to conduct a first fluid and a second feature that is configured to conduct a second fluid,
wherein the body is configured to conduct heat energy from the first fluid to the second fluid, and
wherein the second feature has a surface area that is greater than the surface area of the first feature.

12. A thermal retention device according to claim 11, wherein each of the first feature and the second feature have a nominal diameter, and wherein the nominal diameter of the second feature is smaller than the nominal diameter of the first feature.

13. A thermal retention device according to claim 11, wherein the first feature comprises a centrally-located drain bore that extends along the longitudinal axis.

14. A thermal retention device according to claim 13, wherein the second feature comprises a circuitous fluid pathway that has a single inlet and a single outlet, wherein the circuitous fluid pathway comprises a plurality of legs distributed radially about the centrally-located drain bore, and wherein the second fluid is conducted from the single inlet to the single outlet via the plurality of legs.

15. A thermal retention device according to claim 13, wherein the second feature comprises one or more inlet bores arranged as an array that is disposed radially about the centrally-located drain bore.

16. A thermal retention device according to claim 11, wherein the body comprises a thermally-conductive material with a thermal conductivity of at least about 200 W/m*K and a specific heat capacity of at least about 24 J/mol*K.

17. A thermal retention device according to claim 11, wherein the length of the second feature is greater than the length of the body.
